(19) United States
(12) Patent Application Publication
(10) Pub. No.: US 2011/0050903 A1
(43) Pub. Date: Mar. 3, 2011

(54) METHOD FOR DETERMINING POSITION AND ORIENTATION OF VEHICLE TRAILERS

(75) Inventor: Michael Y. Vorobiev, Moscow (RU)

(73) Assignee: TOPCON POSITIONING SYSTEMS, INC., Livermore, CA (US)

(21) Appl. No.: 12/810,221

(22) PCT Filed: Apr. 8, 2009
(86) PCT No.: PCT/RU2009/000467

§ 371 Date: Jun. 23, 2010

(30) Foreign Application Priority Data
Apr. 8, 2009 (RU) 2009113008

(51) Int. Cl. H04N 7/18

(52) U.S. Cl. 348/148; 348/E07.085

(57) ABSTRACT

A method and system for determining orientation and positioning of a vehicle trailer. A digital camera is placed on a vehicle. The camera is pointed to a trailer attached to the vehicle. The camera acquires images of the trailer. These images are processed and spatial positioning and orientation of the trailer is determined based on image processing. A special marker visible by the camera is set on the trailer. Relative positions of devices attached to the vehicle—global positioning receiver, spatial orientation measuring device and the digital camera are measured. When each digital frame is formed, coordinates and orientation data of the camera are measured. Pixels corresponding to the marker in the image are determined. A simplified copy of the image, containing only the data related to the marker pixels, is generated. The marker pixels are used for calculating position and azimuth orientation of the marker. The azimuth orientation of the trailer is calculated based on calculated azimuth orientation of the marker.

### CROSS-REFERENCE TO RELATED APPLICATIONS

This application is a National Phase of PCT/RU2009/000467, filed on Apr. 8, 2009, which is incorporated herein by reference in its entirety.

### BACKGROUND OF THE INVENTION

1. Field of the Invention

The present invention is related to object orientation and positioning technology, and more particularly, to determining orientation and positioning of vehicle trailers.

2. Description of the Related Art

Conventional methods for determining position and orientation of vehicle trailers are disclosed in U.S. Pat. No. 6,434,462 and U.S. Pat. No. 6,865,465, in which the Global Navigation Satellite system devices (for example, GPS receivers—in the remainder of the text, GNSS will be referred to generically as GPS, for simplicity) are installed on both the vehicle and the trailer. Position and orientation of the trailer is determined based on data from both GPS receivers. The main disadvantage of these methods is the need to use two GPS receiver.

Other conventional methods for determining position and orientation of trailers are discussed in U.S. Pat. No. 7,054,731 and U.S. Pat. No. 7,383,114, in which the GPS receivers are installed only on the trailer. The disadvantage of these methods is low accuracy of determining the orientation of the trailer.

Another method for determining position and orientation of the trailer is disclosed in U.S. Pat. No. 6,581,695, in which a camera is place on a vehicle pointing at a trailer. This camera is used for determining spatial position and orientation of the trailer. The disadvantage of this method is high computational complexity and low accuracy of determining the position and orientation of the trailer.

It is apparent that an improved method for determining spatial position and orientation of the trailer is desired. Accordingly, there is a need in the art for a system and method that addresses the need for efficient and precise determination of positioning of a vehicle trailer.

### SUMMARY OF THE INVENTION

The present invention provides a method and system for determining orientation and positioning of vehicle trailers that substantially obviates one or several of the disadvantages of the related art.

In one aspect, a digital camera is placed on a vehicle. The camera is pointed to a trailer attached to the vehicle. The camera acquires images of the trailer. These images are processed and spatial positioning and orientation of the trailer is determined based on image processing. A special marker visible by the camera is placed on the trailer.

Then, relative positions of devices attached to the vehicle—global positioning device, spatial orientation measuring device and the digital camera are measured. When each digital frame is formed, coordinates and orientation data of the camera are measured. Pixels corresponding to the marker in the image are determined. Then, a simplified copy of the image containing only the data related to the marker pixels is generated.

The spatial position and orientation of the camera are used for correction of perspective distortion of the simplified image frame. The marker pixels are used for calculating position and azimuth orientation of the marker. The azimuth orientation of the trailer is calculated based on calculated azimuth orientation of the marker.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGURES

The accompanying drawings, which are included to provide a further understanding of the invention and are incorporated in and constitute a part of this specification, illustrate embodiments of the invention and, together with the description, serve to explain the principles of the invention.

In the drawings:

FIG. 1 illustrates side view of devices located on the vehicle and on the trailer, in accordance with the exemplary embodiment;

FIG. 2 illustrates a top view of arrangement of devices located on the vehicle and a marker located on the trailer, in accordance with the exemplary embodiment;

FIG. 3 illustrates forming a simplified image frame from a digital image, in accordance with the exemplary embodiment;

FIG. 4 illustrates how exemplary marker coordinates on the simplified image frame are used for calculations.

### DETAILED DESCRIPTION OF THE PREFERRED EMBODIMENTS

Reference will now be made in detail to the preferred embodiments of the present invention, examples of which are illustrated in the accompanying drawings.

According to the exemplary embodiment, a method and system for determining orientation and positioning of vehicle trailer are provided. In one aspect of the invention a digital camera is placed on a vehicle. The camera is rigidly attached and pointed to a trailer attached to the vehicle. The camera acquires images of the trailer. These images are processed by a processing unit located on the vehicle and spatial positioning and orientation of the trailer is determined based on image processing. A special marker visible by the camera is placed on the trailer.

Then, relative positions of devices attached to the vehicle—global positioning system receiver, spatial orientation measuring device and the digital camera, are measured, for example, manually, after installation. These devices are rigidly attached to the vehicle and their relative positions and orientation remain unchanged. When each digital frame is formed by the digital camera, coordinates and orientation data of each of the devices are measured. Pixels corresponding to the marker in the image are determined. Then, a simplified copy of the image containing only the data related to the marker pixels is generated.

The height of the camera position above the marker is measured in advance. The spatial position and orientation of the camera are used for correction of perspective distortion of the simplified image frame. Note that correction of perspective distortion can be performed with the original image as well, prior to generation of the simplified image frame.

The marker pixels are used for calculating position and azimuth orientation of the marker. The position and azimuth orientation of the trailer is calculated from the position and azimuth orientation of the marker, which is rigidly fixed on the trailer and located in the field of view of the camera. The marker should be placed horizontally or at a known angle on the trailer.

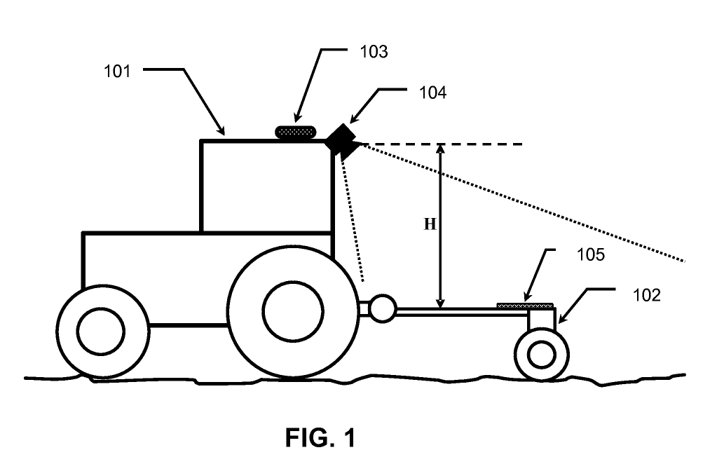

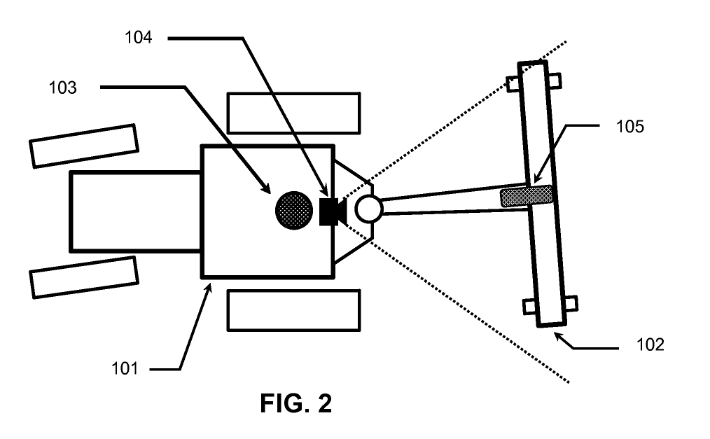

FIGS. 1 and 2 illustrate an exemplary system for implementing a preferred embodiment. A vehicle 101 has a global positioning system receiver 103 (e.g., a GNSS-navigation receiver, such as GPS, GLONASS, GALILEO, etc.), a device for measuring spatial orientation 103 (e.g., an inertial system including a set of gyroscopes and accelerometers) and a digital camera 104. These devices are rigidly attached to (or built into) the vehicle 101. An exemplary device for measuring spatial orientation is an Inertial Measurement Unit (IMU) that includes at least 3 gyroscopes and 3 accelerometers, for example, based on MEMS technology. Gyros and accelerometers data from IMU and position and velocity data from GNSS receiver are used for 3D position and attitude of the vehicle (attitude: 3 angles—pitch, roll, heading in body frame of the vehicle), where the computations use a Kalman Filter (KF) technique, as one example. Expected accuracy for angle estimation should be around 0.1 degree. Position accuracy, obviously, depends on accuracy of the positioning source.

Data read from gyroscopes and accelerometers can be used for spatial orientation calculations. Distances between the antenna of the global positioning system receiver 103, the device for measuring spatial orientation 103 and the digital camera 104 are measured and recorded by a processing unit (not shown). The processing unit is connected to the video camera 104, to the device for measuring spatial orientation 103 and to the GPS receiver 103 by a data channel.

A marker 105 is placed and rigidly attached to a trailer 102 in a field of view of the camera 104. The marker 105 has a predefined shape, color and size. The camera 104 is pointed at the trailer 102. The height H of location of the camera 104 over the marker is measured. Images can be formed by a digital camera with a color matrix, by a camera with a black and white matrix and/or by an infrared camera.

When each digital frame is formed by the digital camera 104, coordinates and orientation data of each of the devices are measured. Pixels corresponding to the marker in the image are determined. Then, a simplified copy of the image containing only the data related to the marker pixels is generated. The height of the camera position above the marker is measured in advance. The spatial position and orientation of the camera 104 are used for correction of perspective distortion of the simplified image frame.

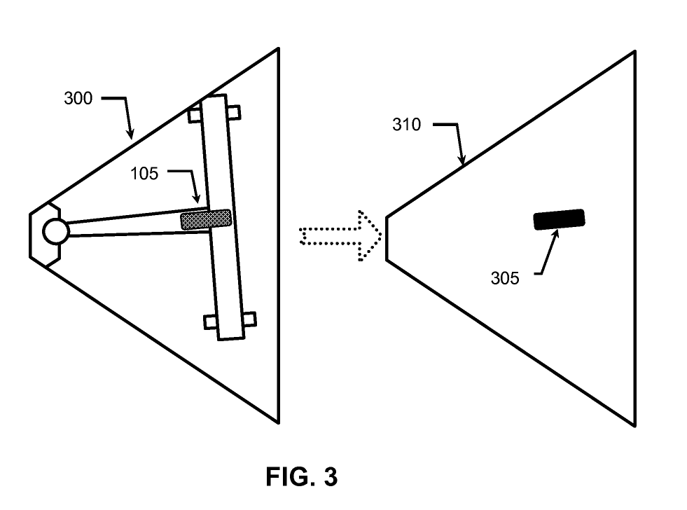

FIG. 3 illustrates forming a simplified image frame from a digital image, in accordance with the exemplary embodiment. The simplified image frame 310 is generated from image 300 produced by the camera 104 using correction of perspective distortions. The simplified image frame 310 contains only data related to pixels 305 corresponding to the marker 105. The pixels 305 reflect data corresponding to the color or emission spectrum of the marker 105.

The simplified image frame 310 contains only the pixels corresponding to the color of the marker 150. Other pixels are excluded from consideration. The pixels 305 can be determined based on configuration (i.e., shape) of a group of pixels approximately matching the shape of the marker 105. In order to determine approximate match between the image of the marker and the group of pixels, a correlation method is used. The marker can have a rectangular shape with dimension of about 20×50 cm, or it can be two separate round markers with 20 cm diameter and 1 m distance between each other. Marker color should be opposite (or at least different) relative to trailer color—for example, if trailer color is mostly blue, marker color should be red. Surface of marker should block sunlight reflections to prevent overexposing the video-matrix.

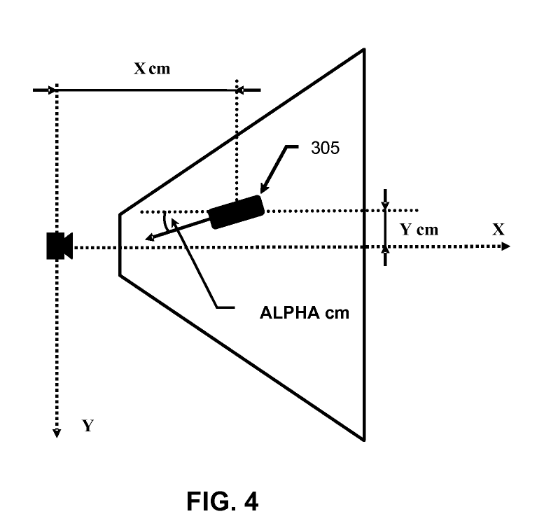

FIG. 4 illustrates how exemplary marker coordinates on the simplified image frame are used for calculations. The marker 105 is represented by a group of pixels 305. The peak of maximum correlation between the remaining pixels of the simplified image frame and the original image of the marker will have coordinates of the marker (Xcm, Ycm, ALPHAcm) relative to the camera position, where:

Xcm—lateral coordinate relative to the location and orientation of the camera;

Ycm—longitudinal coordinate relative to the camera;

ALPHAcm—an angle of location of the marker relative to the camera's viewing axis Y.

The processing unit (not shown) processes the camera frames and data received from the positioning and orientation devices and calculates the position and azimuth orientation of the trailer. Using positioning data of GNSS-receiver and an inertial system in relation to the camera, a global position (LONc, LATc, Hc) and spatial orientation (ALPHAc, BETAc, GAMMAc) of the digital camera are calculated, where:

LONc—a longitude coordinate of the camera;

LATc—a latitude coordinate of the camera;

Hc—a coordinate of the camera height;

ALPHAc—an azimuth angle of the camera;

BETAc—a declination angle of the camera;

GAMMAc—an angle of lateral inclination of the camera.

According to the position and the orientation of the camera, the position and azimuth orientation of the marker located on the trailer is calculated.

For the northern latitude and eastern longitude the following conversion is true:

LONm=LONc+a tan [(Xcm*cos(ALPHAc)−Ycm*sin(ALPHAc))/(R+Hm)]

LATm=LATc+a tan [(Xcm*sin(ALPHAc)+Ycm*cos(ALPHAc))/(R+Hm)]

Hm=Hc−H

ALPHAm=−ALPHAc−ALPHAcm,

where:

LONm—longitude of the marker;

LATm—latitude of the marker;

Hm—the height of the marker;

ALPHAm—azimuth of the marker;

R—radius of the earth.

Because of the rigid fixation of the marker on the trailer, its azimuth orientation coincides with the orientation of the orientation of the trailer and its position corresponds to the measured position of the trailer.

Based on the position of the marker pixels on the simplified image frame and based on the position and orientation data of the camera, the position and azimuth orientation of the marker are calculated, which are, in turn, used for calculating the position and azimuth orientation of the trailer.

Any object or a group of objects having certain color, shape, size and defined position on the trailer can be used. The marker can be covered with reflective coating and the marker can be supplemented with a source of emission of a known spectrum. In poor lighting conditions, illumination devices can be used on the vehicle and on the trailer, such as standard light lamps that are already installed on the vehicle or some other light sources like visible light lamps. The illumination device can be pointed at the marker. The image can be generated by a digital camera with a matrix sensitive to the emission spectrum of the illumination device.

For more accurate measurements of position and orientation of the marker, a second camera can be installed on the vehicle. Then, as the image is generated by one camera, a different image can be formed by another camera. The images from both cameras are processed in the same way as described above. Then, using locations of the marker pixels on the simplified images from both cameras and position and orientation data of the both cameras, three dimensional position and orientation of the marker are calculated. Accordingly, three dimensional position and orientation of the trailer are calculated.

In order to determine the spatial orientation angles of the marker, known methods of processing stereo images, such as the one described in the U.S. Pat. No. 5,179,441, can be used. Additionally, three independent and spatially separated GNSS-receivers, or a single GNSS-receiver with three spatially separated antennas connected to the receiver via an antenna hub can be used instead of the inertial system of spatial orientation.

Additionally, for more precise determination of coordinates of global positioning, the global positioning coordinates at the point of forming an image frame can be measured using a differential positioning mode. The device of coordinate global positioning can be implemented with a capability of receiving and processing differential corrections (i.e., WAAS (http:**en.wikipedia.org/wiki/Wide_Area_Augmentation_System), EGNOS (http:**en.wikipedia.org/wiki/European_Geostationary_Navigation_Overlay_Service), OmniStar VBS, HP (http:**en.wikipedia.org/wiki/OmniSTAR) or RTK (http:**en.wikipedia.org/wiki/Real_Time_Kinematic)). The accuracy of trailer position can reach 0.01 m, trailer orientation—0.1 deg. As long as the distance between marker and camera is constant, the accuracy should remain substantially constant. Generally accuracy is a function of camera video-matrix resolution, and higher resolution provides more accurate solution. Another factor is video-matrix light sensitivity. Yet another factor is video-matrix or optical vibration stabilization, to prevent accuracy degradation caused by camera vibration.

Having thus described a preferred embodiment, it should be apparent to those skilled in the art that certain advantages of the described method and apparatus have been achieved. In particular, those skilled in the art would appreciate that the proposed system and method provide for an efficient automated determination of orientation and positioning of vehicle trailer.

It should also be appreciated that various modifications, adaptations and alternative embodiments thereof may be made within the scope and spirit of the present invention. The invention is further defined by the following claims.

What is claimed is:

1. A method for determining position and orientation of a trailer attached to a vehicle, the method comprising:
(a) placing a video camera on the vehicle so that the camera is pointed at the trailer;
(b) attaching a global navigation satellite system (GNSS) receiver to the vehicle;
(c) mounting, on the vehicle, a device for measuring spatial orientation;
(d) generating relative positions of the GNSS receiver, the measuring device and the camera;
(e) placing a marker on the trailer in a field of view of the camera;
(f) measuring a height of the camera's location relative to the marker;
(g) storing global positioning coordinates and spatial orientation data when forming an image of the trailer by the camera;
(h) identifying, in the image, pixels corresponding to the marker;
(i) generating a simplified image frame containing only the pixels corresponding to the marker;
(j) calculating spatial position and orientation of the camera based on the height of the camera and the relative positions;
(k) correcting perspective distortion of the simplified image frame based on the spatial position and the orientation of the camera;
(l) calculating azimuth orientation of the marker based on positioning of the marker pixels on the simplified image frame and the position and the orientation of the camera; and
(m) determining azimuth orientation of the trailer based on the azimuth orientation of the marker.

2. The method of claim 1, wherein the global positioning coordinates are measured using a differential mode.

3. The method of claim 1, wherein the spatial orientation data is acquired from a gyroscope and an accelerometer.

4. The method of claim 1, wherein the image is formed by a digital camera with a color matrix of visible spectrum.

5. The method of claim 1, wherein the image is formed by a digital camera with a black and white matrix of visible spectrum.

6. The method of claim 1, wherein the image is formed by a digital camera with an infrared spectrum matrix.

7. The method of claim 1, wherein the marker is illuminated by an illumination device and the image is formed by the camera with a matrix operable in a spectrum of the illumination device.

8. The method of claim 1, wherein a second camera is set on the vehicle and the images acquired by the second camera are processed using the steps of claim 1.

9. The method of claim 8, wherein the images from the second camera are used to determine orientation of the trailer.

10. The method of claim 1, wherein the simplified image frame is generated by excluding from processing pixels, having color different from the one of the marker.

11. The method of claim 1, wherein the marker pixels are determined by match of positioning and shape of a group of pixels to size and shape of the marker.

12. A method for determining position and orientation of a trailer attached to a vehicle, the method comprising:
(a) placing a video camera on the vehicle so that the camera is pointed at the trailer;
(b) attaching a global navigation satellite system (GNSS) receiver to the vehicle;
(c) mounting, on the vehicle, a device for measuring spatial orientation;
(d) generating relative positions of the GNSS receiver, the measuring device and the camera;
(e) placing a marker on the trailer in a field of view of the camera;
(f) measuring a height of the camera's location relative to the marker;
(g) storing global positioning coordinates and spatial orientation data when forming an image of the trailer by the camera;
(h) calculating spatial position and orientation of the camera based on the height of the camera and the relative positions;
(i) correcting perspective distortion of the image frame based on the spatial position and the orientation of the camera;
(j) identifying, in the image, pixels corresponding to the marker;
(k) generating a simplified image frame containing only the pixels corresponding to the marker;
(l) calculating azimuth orientation of the marker based on positioning of the marker pixels on the simplified image frame and the position and the orientation of the camera; and
(m) determining azimuth orientation of the trailer based on the azimuth orientation of the marker.

13. A system for determining position and orientation of a trailer attached to a vehicle, the system comprising:
a video camera placed on the vehicle for generating digital images of the trailer;
a processing unit connected to the camera via data channel;
a global coordinate positioning device connected to the processing unit via a data channel;
a device for measuring spatial orientation and connected to the processing unit via the data channel; and
a marker located on the trailer in a view field of the camera, wherein the processing unit processes image data from the camera and calculates position and azimuth orientation of the trailer based on the data from the global coordinate positioning receiver and data from the device for measuring spatial orientation.

14. The system of claim 13, wherein the global coordinate positioning device uses a differential mode.

15. The system of claim 13, wherein the device for measuring spatial orientation comprises accelerometers and gyroscopes.

16. The system of claim 13, wherein the global coordinate positioning device and the device for measuring spatial orientation are combined into GNSS-receiver with three spatially separate antennas connected to the receiver via a hub.

17. The system of claim 13, wherein the digital camera has a color matrix of visible spectrum.

18. The system of claim 13, wherein the digital camera has a black and white matrix of visible spectrum.

19. The system of claim 13, wherein the digital camera has an infrared matrix of visible spectrum.

20. The system of claim 13, wherein the marker is illuminated by an illumination source.

21. The system of claim 13, wherein a second camera is placed on the vehicle and connected to the processing unit.

22. The system of claim 13, wherein the marker is an object defined by any of known parameters:
an object size;
an object shape;
an object color; and
a composition of object's parts.

23. The system of claim 13, wherein the marker comprises several objects with known parameters.

24. The system of claim 13, wherein the marker is covered by a reflective coating.

25. The system of claim 13, wherein the marker comprises at least one source of emission of a known spectrum.
